(19) United States
(12) Patent Application Publication
(10) Pub. No.: US 2008/0199683 A1
(43) Pub. Date: Aug. 21, 2008

(54) Ornamental Films

(75) Inventors: Ken Egashira, Kanagawa (JP); Shinji Ikeda, Shizuoka Prefecture (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 11/813,573

(22) PCT Filed: Jan. 10, 2006
(86) PCT No.: PCT/US2006/000821

§ 371 Date: Mar. 18, 2008

(30) Foreign Application Priority Data
Jan. 11, 2005 (JP) 2005-004067

(51) Int. Cl. B32B 7/12; B32B 5/16

(52) U.S. Cl. 428/323; 428/337; 428/354

(57) ABSTRACT

An ornamental film comprising a base member, a coloring layer formed at least partly on the surface of the base member, and a pressure-sensitive adhesive layer formed on the back surface of the base member, wherein said base member is blended, as a filler, with inorganic or organic non-spherical fine particles selected from the group consisting of aluminum borate, zinc oxide, potassium titanate, carbon, alumina, silica-calcia-magnesia and nylon.

### FIELD OF INVENTION

This invention relates to an ornamental film. More specifically, the invention relates to an ornamental film which can be used, for example, as an armoring or protective member for automobiles. The inventive film can improve the appearance and weather-proof property of the surface it is adhered to. The inventive film can also exhibit an improved three-dimensional curved surface follow-up property, as well as an improved scratch resistance, even when the base member is blended with the filler in only small amounts. In addition, the inventive film can exhibit anisotropy in its tensile strength.

### BACKGROUND

The ornamental film used as an armoring member of automobiles has, as is widely known, a layer constitution including a resin film as a base member (also called base), a coloring layer (also called appearance-imparting layer or appearance design layer) formed by printing on the surface thereof, a clear layer (also called top-coated layer) laminated thereon for protection purpose, and a pressure-sensitive adhesive layer applied onto the back surface of the base member. Further, each layer is made of a material having flexibility at normal temperature enabling the ornamental film itself to be stuck to a three-dimensional curved surface or to any other body having a complex shape. However, the film having flexibility is subject to be exposed to mechanical shocks in a state where it is stuck to the body (in the case of, for example, an automobile, the ornamental film is quite often get scratched by the hand of a driver, by a key, by a bag, etc.). Depending upon the cases, the ornamental film is often damaged. The damage is invited due presumably to the presence of the pressure-sensitive adhesive layer, coloring layer and clear layer thereon, which are soft and permit the film to be easily deformed. To prevent the above problem, it can be contrived to use, as a base member, a hard plastic film such as a biaxially stretched polyethylene terephthalate film between the pressure-sensitive adhesive layer and the coloring layer. In this case, the obtained ornamental film exhibits improved resistance against being scratched accompanied, however, by a serious problem of loss of three-dimensional curved surface follow-up property due to an increased hardness.

Japanese Unexamined Patent Publication (Kokai) No. 8-157746, though not related to the composite ornamental film comprising a base member, a coloring layer and a pressure-sensitive adhesive layer, proposes an aqueous coating material composition for blackout for improving the hardness of the coated film and for imparting scratch resistance, This coating material composition comprises a vinylidene chloride resin emulsion, a black coating material of carbon black, and a filler of a hard and spherical particulate shape selected from one or more of calcium carbonate, calcium sulfate, silica, barium sulfate and magnesium carbonate. However, the idea of this invention for improving the scratch resistance is effective in only a coating film of white color stemming from the filler itself such as calcium carbonate and a coating film of black color which is little affected by opaqueness, but cannot be applied to the ornamental films having other colors or to the ornamental films featuring improved design by being graphic-printed. In the case of this coating composition, further, the filler must be blended in such large amounts as 35 to 180 parts by weight per 100 parts by weight of a solid component of the vinylidene chloride resin emulsion.

Further, though this is not to improve the scratch resistance, there has been proposed to blend the base member and other layers with various fillers to improve the strength and other properties. For example, Japanese Unexamined Patent Publication (Kokai) No. 6-25463 proposes an internal adhesion-preventing agent for a resin film effective in the production of resin films having excellent anti-blocking property and sliding property. This internal adhesion-preventing agent comprises a particulate or needle-like aluminum borate having an average particle size of 0.1 to 50 μm as an effective ingredient.

Further, Japanese Unexamined Patent Publication (Kokai) No. 6-220408 proposes an adhesive tape or a sheet effective in the production of dust-proof mats having antistatic effect. This adhesive tape or sheet is formed by applying, onto one surface of a support member, an electrically conducting coating material blended with an electrically conducting whisker obtained by forming an electrically conducting film such as a carbon film on the surface of an electrically insulating whisker such as an alkali metal titanate whisker, a titanium oxide whisker, an aluminum borate whisker or a magnesium pyroborate whisker, and, then, applying a sticking agent or an adhesive onto the surfaces thereof.

### SUMMARY OF THE INVENTION

The present inventors are engaged in the research and development of ornamental films useful, particularly, as an armoring or protective member for automobiles, and have recently invented an ornamental film improving both the scratch resistance and the three-dimensional curved surface follow-up property as disclosed in Japanese Patent Application No. 2004-15806 (filed Jan. 23, 2004). This ornamental film has a feature in that the base member is blended with fine particles of a hard filler, and exhibits improved appearance design and weather-proof property while, at the same time, satisfying scratch resistance and three-dimensional curved surface follow-up property.

In the case of this ornamental film, however, fine particles of the hard filler must be blended in an amount of about 15 to about 70% by weight based on the whole amount of the base member. It has, therefore, been desired to obtain a relatively excellent effect with a small blending amount. When consideration is given to using the ornamental film as an armoring or protective member for the automobiles, it is desired that the ornamental film has anisotropy in the tensile strength, i.e., has different tensile moduli or, in other words, is controllable depending upon the MD/CD.

It is, therefore, an object of the present invention to provide an improved ornamental film comprising a typical layer structure, i.e., pressure-sensitive adhesive layer/base member/coloring layer, improving appearance design and weather-proof property, exhibiting improved scratch resistance and improved three-dimensional curved surface follow-up property even when the base member is blended with a filler in reduced amounts and, further, exhibiting anisotropy in the tensile strength.

Further, the invention has an object of providing an ornamental film capable of exhibiting its effect when used, particularly, as an armoring member for automobiles.

The present inventors have conducted keen study to provide an ornamental film capable of exhibiting particularly improved scratch resistance even when it is blended with a small amount of a filler, and exhibiting anisotropy in the tensile strength, and have invented an improved ornamental film as described hereinafter.

As described below in detail, the present invention is concerned with an ornamental film comprising a base member, a coloring layer formed at least partly on the surface of the base member, and a pressure-sensitive adhesive layer formed on the back surface of the base member, wherein the base member is blended, as a filler, with inorganic or organic non-spherical fine particles selected from the group consisting of aluminum borate, zinc oxide, potassium titanate, carbon, alumina, silica-calcia-magnesia and nylon.

### BRIEF DESCRIPTION OF THE DRAWINGS

FIG. 1 is a sectional view illustrating the constitution of an ornamental film of the present invention.

FIGS. 2a, 2b and 2c are schematic views illustrating a testing method used for evaluating three-dimensional curved surface follow-up property.

### DETAILED DESCRIPTION OF EMBODIMENTS

According to the present invention, as will be appreciated from the following detailed description, there is provided an ornamental film that can be capable of exhibiting both good scratch resistance and good three-dimensional curved surface follow-up property or compatibility in addition to exhibiting excellent ornamental effect and weather-proof property.

In particular, according to the present invention, the ornamental film can exhibit improved scratch resistance even when it is blended with the filler in only small amounts and, further, can exhibit anisotropy in the tensile strength.

Furthermore, according to the present invention, the ornamental film is used, particularly, as an armoring member for automobiles to draw excellent properties of the film to a sufficient degree.

The ornamental film according to the present invention can be carried out in a variety of embodiments. The ornamental film of the present invention will now be described in its preferred embodiments but it should be noted that the invention is in no way limited to the following embodiments only.

The ornamental film of the invention can be advantageously used being stuck to various bodies that require ornamental and design appeal. Further, the ornamental film of the invention has a weather-proof property and can be advantageously used for a variety of moving bodies used indoors or outdoors, such as ships like excursion ships, yachts, motor boats, etc., vehicles such as electric cars and the like, and car bodies such as of automobiles. In particular, the ornamental film satisfies both scratch resistance and three-dimensional curved surface follow-up property, simultaneously, and can be advantageously used by being stuck to the car bodies of various automobiles and onto the parts thereof. Here, the word “automobiles” include trucks, buses, passenger cars, as well as motor cycles, scooters, and the like. Further, though not limited to those listed below only, the parts of the automobiles include, for example, laces such as side guard laces, pillars and the like.

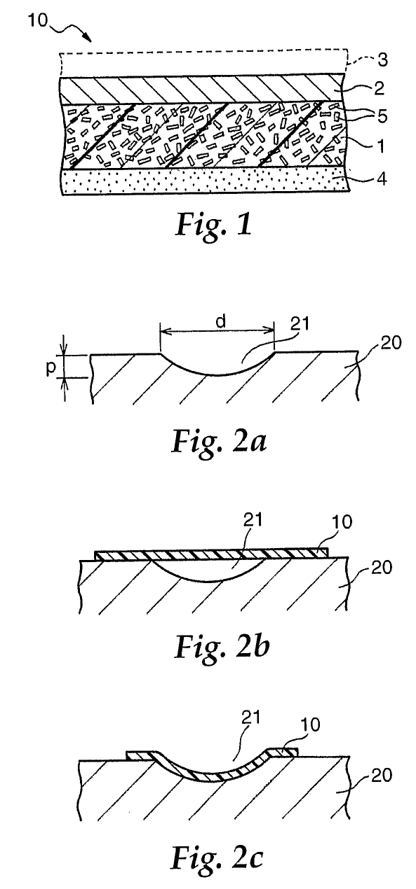

FIG. 1 schematically illustrates a representative example of an ornamental film according to the present invention. The ornamental film 10 includes at least a base member 1, a coloring layer 2 at least partly formed on the surface of the base member 1 (in FIG. 1, the coloring layer 2 is formed on the whole surface of the base member 1), and a pressure-sensitive adhesive layer 4 formed on the back surface of the base member 1. The ornamental film 10 is stuck to an automobile or any other body (not shown) via the pressure-sensitive adhesive layer 4, and is secured thereto. Though the ornamental film 10 is represented by a dotted line in the drawing, a top-coated layer (a clear layer is applied herein) 3 may be further formed on the coloring layer 2. Further, though not shown, the pressure-sensitive adhesive layer 4 is usually protected by a peel paper (also called release liner) until the ornamental film 10 is stuck to the body.

In the ornamental film 10 of the present invention, it is necessary that the base member 1 is blended, as a filler 5, with a particular inorganic or organic material selected from the group consisting of aluminum borate, zinc oxide, potassium titanate, carbon, alumina, silica-calcia-magnesia and nylon. It is further necessary that the filler 5 is blended in the form of, particularly, non-spherical fine particles. According to the present invention blended with a particular filler in the form of non-spherical fine particles, the ornamental film after stuck to the body exhibits excellent scratch resistance even when the filler is blended in an amount of about 15% by weight or smaller, for example, in an amount of about 5% by weight based on the whole amount of the base member. The present invention further improves the three-dimensional curved surface follow-up property of the ornamental film together with the scratch resistance, and makes the ornamental film free from such problems as being scratched, damaged or pierced.

The base member can be made of various materials and can preferably and advantageously be constituted by using films of various plastic materials from the standpoint of workability and blending with the filler. Though not limited to those listed below, examples of the plastic film that can be preferably used as the base member include films made of such resins as a reactive polyurethane resin, a polyester resin, a polyolefin resin and the like resins. The film is usually used as a single layer. However, as required, the films may be used as a laminate or a composite of two or more layers of the same resin or of different resins,

Especially, the reactive polyurethane resins (PUR) include those obtained by reacting and curing a polyol containing an OH group such as of acrylics, polyester or polyether, and an isocyanate such as a hexamethylene diisocyanate (HDI) containing an NCO group, an isoboron diisocyanate (IPDI), tolylene diisocyanate (TDI) or methylenebis 4-phenyl isocyanate (MDI) or a polymer of such isocyanate, which includes a buret, isocyanurate or an adduct thereof.

As the polyester resin, further, there can be used thermoplastic saturated copolymerized polyester resins having various molecular weights and Tg, which are available as, for example, “ELITEL™” Series from Unitica Co. and “VYLON™” Series from Toyoboseki Co.

Further, the polyolefin resins include a polypropylene (PP), a polyethylene (PE), a thermoplastic olefin (TPO: usually a blend of PP and a rubber component such as EPDM (ethylene/propylene/diene monomer copolymer)), an ionomer, EAA (ethylene/acrylic acid copolymer), EEA (ethylene/ethyl acrylate copolymer) and EVA (ethylene/vinyl acetate copolymer).

The above-mentioned base member may be transparent, translucent or opaque depending upon the use object of the ornamental film or the desired ornamental effect. Further, the base member contains non-spherical fine particles of a particular filler as an essential component for improving the scratch resistance as will be described below in detail. To further improve the appearance and ornamental property, the base member may further additionally contain a variety of dyes, pigments or any other coloring agents, such as phthalocyanine blue pigment, azo red pigment, aluminum flakes or mica powder. Any other additives such as ultraviolet ray absorber may be further contained.

The filler used in the form of non-spherical fine particles in the practice of the present invention is a particular inorganic or organic material. As the inorganic material, there can be used aluminum borate, zinc oxide, potassium titanate, carbon, alumina or silica-calcia-magnesia, As the organic material, a nylon (polyamide) is exclusively used. The filler is usually used in a single kind. As desired, however, two or more kind of fillers may be used in combination.

Further, the filler of a non-spherical shape can be used in the form of various non-spherical particles, usually, excluding spherical and elliptic shapes. The non-spherical fine particles are typically fine particles having acute-angled portions like fibers or whiskers. As desired, the non-spherical fine particles may be a mixture of fibers and whiskers.

Though the non-spherical fine particles can be used in a variety of sizes depending upon the kind of the filler that is used and the desired effect, it is usually desired that the length thereof is in a range of about 2 to about 200 μm on the average. When the length of fine particles is not larger than 2 μm, there does not appear the effect of adding a particular filler in the form of non-spherical fine particles. When the length exceeds 200 μm, on the other hand, there does not appear the effect of adding a particular filler in the form of non-spherical fine particles and, besides, there occur such inconvenience as ruggedness in the surface of the base member spoiling the smoothness on the surface of the film when the ornamental film is stuck to the body. More preferably, the length of the non-spherical fine particles is about 5 to about 50 μm on the average. Further, like the length, the diameter of the non-spherical fine particles can be varied over a wide range but is, usually, in a range of about 0.2 to about 20 μm on the average and, preferably, about 0.3 to about 1.0 μm on the average.

In the practice of the present invention, the scratch resistance is remarkably improved and, at the same time, other effects are also achieved by blending the base member with the non-spherical fine particles of the above-mentioned particular filler in only small amounts, which is contrary to the generally accepted idea in the prior art, though the non-spherical fine particles may be blended in large amounts in a customary manner if it is desired.

The non-spherical fine particles are, usually, used in an amount in a range of about 2 to about 60% by weight and, preferably, in a range of about 2 to 15% by weight based on the whole amount of the base member. When the blending amount of non-spherical fine particles is smaller than 2% by weight, there occurs such an inconvenience that the scratch resistance cannot be improved. On the other hand, when the blending amount exceeds 60% by weight, a sufficiently large cohesive force is not obtained in the base member blended with the fine particles making it difficult to improve the scratch resistance and spoiling softness that is necessary for attaching the ornamental film to the body. More preferably, the non-spherical fine particles are blended in an amount in a range of about 5 to about 15% by weight. From the practical point of view, the improved scratch resistance according to the present invention stands for that the film surface properties are improved to such a degree that the film surface is not really scratched or damaged even when the ornamental film stuck to the body is hit and scratched by the hand or the articles.

With regard, to the “scratch resistance” of the ornamental film, it can be evaluated in teems of a pencil scratch value measured in compliance with a method (hand-scratching method) of measuring pencil scratch values specified under the Japanese Industrial Standards JIS K5400 8.4.2. That is, by using pencils of core hardnesses of 9H to 6B specified under JIS S6006, the surfaces of the sample ornamental films are drawn with a load of 1 kg at a scratching angle of 45 degrees 5 times, and damage to the films is observed by naked eyes. The samples having damage in the film are represented by X and the samples without damage in the film are represented by O. Upon scratching 5 times, the samples without damage (O) to the films even after 3 or more times by using the highest core hardness was regarded to be a pencil scratch value (judging level).

According to the present invention, especially when the non-spherical fine particles are blended in an amount of about 15% by weight or less, the obtained ornamental film exhibits strikingly improved scratch resistance as well as favorable three-dimensional curved surface follow-up property, that were not expected so far. The present inventors have found that, even when the blending amount of the non-spherical filler is increased to be not smaller than 15% by weight through up to about 60% by weight, the scratch resistance is not improved to an appreciable degree.

Though the base member blended with the non-spherical fine particles of the filler, usually, exhibits a white and opaque appearance, the ornamental film of the invention does not at all adversely affect the appearance desired for the ornamental film since it employs a layer constitution arranging the base member on the lower side of the coloring layer that works as an appearance-imparting layer or an appearance design layer.

As described above, the ornamental film of the present invention uses the base member blended with non-spherical fine particles of the filler. The base member is, desirably, a coated film or a film made of a base member-forming material relying on the coating method. The base member in the form of a coated film is prepared by homogeneously dispersing the non-spherical fine particles of the filler in a coating solution of the base member-forming material with, for example, stirring, and applying the solution by the coating method such as a knife coating method, a bar coating method, a blade coating method, an air doctor coating method, a roll coating method or a cast coating method, followed by drying. Further, the coloring layer and the pressure-sensitive adhesive layer can be laminated simultaneously or nearly simultaneously with the preparation of the base member.

In the ornamental film of the present invention, the anisotropy in the tensile strength is improved or is controlled in preparing the base member in the form of the coated film by, for example, the bar coating method as described above. This is because, the non-spherical fine particles are aligned and oriented in the base member-forming material in the step of coating. When the film is formed by the spray-coating method according a customary manner, the non-spherical particles are arranged in a random fashion, and the anisotropy does not develop in the tensile strength.

The present inventors have found that, when the base member is prepared by the above coating method, in general, the tensile modulus in the MD direction (machine direction); (coating direction) becomes greater than that in the CD (direction at right angles with the MD). By changing the kind and the blending amount of the non-spherical fine particles that are used, however, the difference in the MD/CD moduli of when the ornamental film as a whole is considered can be adjusted to be brought into substantial zero or to become considerably great. As will be understood from the foregoing, the ornamental film of the present invention is expected to be stuck to the bodies having three-dimensional curved surfaces of various shapes. Therefore, having a low tensile modulus in a given direction may be often advantageous for being stuck to the body. Further, when the ornamental film is handled in the form of a roll, a high tensile modulus in the MD (machine direction) offers an advantage of little elongation at the time of taking up.

The base member blended with the non-spherical fine particles of the above filler can be used having a thickness dependent upon the use of the ornamental film and, usually, has a thickness in a range of about 10 to about 1,000 μm. When the thickness of the base member is not larger than 10 μm, the effect of the filler that is blended and a support function are not exhibited to a sufficient degree. When the thickness of the base member is not smaller than 1,000 μm, on the other hand, the thickness of the ornamental film as a whole becomes so large that the appearance and the workability are inevitably deteriorated, More preferably, the thickness of the base member is in a range of about 30 to about 200 μm.

The coloring layer supported by the base member can be formed of various materials and is, usually, formed of a binder resin, a coloring agent and a solvent. As the binder resin, there can be used, for example, a polyurethane resin, a polyester resin or a polyolefin resin. As the coloring agent, there can be used pigments such as titanium oxide, carbon black, iron oxide, perylene pigment, azo pigment, and phthalocyanine pigment, dyes such as disazo dye and anthraquinone dye, brightening agents such as aluminum flakes and pearl powder, and the like. As the solvent, there can be used, for example, an organic solvent, water, or a mixture of water and alcohols. As required, further, there can be used a pigment dispersant, a photostabilizer, a heat stabilizer, an ultraviolet ray absorbent, a leveling agent, a defoaming agent, a viscosity-increasing agent and an antistatic agent in one kind or in combination.

Further, the coloring layer can be formed in various patterns depending upon a desired design and ornamental effect, and may be formed on the whole surface of the base member or may be formed on a portion thereof (i.e., not on the whole surface thereof). Further, the coloring layer can be formed by various techniques. For example, there can be advantageously used such techniques as printing, transferring, vacuum evaporation, film sticking or spray coating. As required, these techniques may be used in combination.

When the coloring layer is formed by, for example, printing, there can be employed a screen-printing method such as a silk screen high-resolution printing, an offset printing method, a photogravure printing method, or an ink jet printing method. Any printing ink can be used that is suited for the printing method.

The coloring layer can be used in any thickness, usually, in a range of about 1 to about 300 μm. When the thickness of the coloring layer is not larger than 1μ, the appearance design is no longer achieved to a sufficient degree. When the thickness exceeds 300 μm, on the other hand, the appearance design is not improved proportionally. More desirably, the thickness of the coloring layer is in a range of about 5 to about 100 μm.

The ornamental film of the present invention may further include a transparent top-coated layer formed on the surface thereof. The top-coated layer is preferably formed of an urethane resin. The urethane resin used here is, preferably, a two-can urethane resin. The urethane resin is effective, particularly, in regard to imparting weather-proof property and scratch resistance to the ornamental film.

Like the base member, the top-coating layer may be also transparent, translucent or opaque depending upon the use object of the ornamental film. A transparent top-coated layer (clear layer) is preferred. To improve the appearance or ornamental property, further, the top-coated layer may further additionally contain a variety of dyes, pigments or other coloring agents such as phthalocyanine blue pigment, azo red pigment, aluminum flakes or mica powder. The top-coated layer may further contain other additives such as an ultraviolet ray absorber and a luster-adjusting agent. The ultraviolet ray absorber works to effectively prevent the ornamental film and the underlying part from being deteriorated while they are being exposed to sunlight, and the luster-adjusting agent works to impart excellent luster to the surface of the ornamental film.

As described above, the top-coated layer can be used having a thickness that varies depending upon the use object of the ornamental film and, usually, having a thickness, preferably, in a range of about 1 to 300 μm. When the thickness of the top-coated layer is not larger than 1 μm, a sufficient degree of weather-proof property and scratch resistance cannot be imparted to the ornamental film. Even when the thickness exceeds 300 μm, on the other hand, its function is not distinctly improved. More preferably, the thickness of the top-coated layer is in a range of about 5 to about 100 μm. The top-coated layer is, usually, used as a single layer but, as required, may be used in a multi-layer structure having two or more layers.

In the ornamental film of the present invention, a carrier film may be provided on the side of the top-coated layer to improve the handling of the ornamental film. The carrier film that is used here is preferably a peelable carrier film. The carrier film covers the top-coated layer, usually, until the ornamental film is stuck to the body. After the ornamental film has been stuck, the carrier film is peeled off the top-coated layer and is removed. The carrier film further works to impart excellent surface luster to the top-coated layer. That is, after the top-coated layer is applied but before it is cured, the carrier film having its luster adjusted is laminated on the surface of the top-coated layer to reproduce any surface luster of from as high as about 90 down to as low as about 20 or smaller in the step of curing the top-coated layer.

Though not limited to those listed below, examples of the carrier film that can be preferably used for putting the invention into practice include PET, PEN, polyimide (CAPTON™) and PP. The carrier film can be used having a thickness that varies depending upon the use of the ornamental film but that, usually, is in a range of, preferably, about 5 to about 500 μm and, more preferably, about 12 to about 100 μm.

The ornamental film of the present invention further comprises a pressure-sensitive adhesive layer for being stuck to the body. This layer can be arbitrarily formed by using an ordinary pressure-sensitive adhesive agent. Though not limited to those listed below, examples of the pressure-sensitive adhesive agent that can be preferably used for the practice of the invention into practice include adhesives of the type of rubber, acrylics, olefin, polyester and polyurethane. The acrylic adhesive agent is particularly preferred for the formation of the pressure-sensitive adhesive layer.

The pressure-sensitive adhesive layer can be used having any thickness which, usually, is in a range of, preferably, about 5 to about 300 μm. When the thickness of the pressure-sensitive adhesive layer is not larger than 5 μm, a desired adhesive force may not be obtained. Even when the thickness exceeds 300 μm, on the other hand, more improved adhesive force cannot be expected. More preferably, the thickness of the pressure-sensitive adhesive layer is in a range of about 20 to about 100 μm.

In order to further improve the appearance and properties, the ornamental film of the present invention may further have any additional layer. Besides, the position for arranging the additional layer can be arbitrarily selected. As a suitable additional layer, there can be exemplified an adhesive layer for joining the layers together, a base material layer for color coating and a base layer for imparting stiffness to the film as a whole.

The ornamental film of the present invention can be produced by various methods that are usually used for forming films. A preferred production method is the one for producing a sheet of longitudinal film by simultaneously or nearly simultaneously molding, for example, the base member, the coloring layer and, as required, the top-coated layer and the carrier film. Such a longitudinal film may be preserved in its form or may be preserved being wound as a roll after the pressure-sensitive adhesive layer and the peeling paper have been laminated on the back surface of the base member. When wound in the form of a roll, the ornamental film of the present invention exhibits a noticeable effect in that it elongates little.

As the peeling paper, there can be used a peeling paper, a separating paper or a release paper that is, usually, used for the adhesive tapes in their own forms or by being modified. For example, a paper applied with a silicone compound can be advantageously used.

The ornamental film of the present invention is stuck to a predetermined body via the pressure-sensitive adhesive layer, for example, to the body and armoring parts of automobiles. Referring, for example, to armoring parts of an automobile, it is desired that the armoring parts are made of, particularly, an olefin resin such as a polypropylene resin. The above resin can be favorably molded and machined in addition to favorably absorbing shocks. The ornamental film of the present invention can, as required, be stuck to armoring parts made of materials other than the olefin resin, as a matter of course. Even when the body has a three-dimensional curved surface, the ornamental film of the present invention can be easily and intimately adhered without any inconvenience.

According to the present invention, there is further provided an ornamented article comprising a body or an armoring part of an automobile and an ornamental film of the invention stuck to the exposed surface of the body or of the armoring part (i.e., surface exposed when mounted on an automobile and on which the ornamental film of the invention is to be stuck).

### EXAMPLES

The invention will be further described in detail with reference to examples and comparative examples. Note, however, that the present invention is in no way limited to the following examples only.

### Description of the Material Used:

The following materials were used for producing ornamental films.

| Product name | Available from | Details |
|---|---|---|
| Pluxcel L212A1 | Dycel Kagaku | caprolactone polyol |
| | Kogyo Co. | |
| Desmodule | Sumitomo-Bayer | IPDI trimer |
| Z4470 | Urethane Co. | |
| Alborex YS4 | Shikoku Kasei Co. | aluminum borate whisker |
| | | (9Al₂O₃, 2B₂O₃) |
| Panatetra | Matsushita | zinc oxide whisker |
| WZ-0501 | Amrack Co. | (ZnO) |
| Tismo N | Ohtsuka Kagaku Co. | Potassium titanate |
| | | whisker |
| | | (K₂O, 6TiO₂) |
| K6371M | Mitsubishi Kagaku | carbon fiber (with |
| | Sanshi Co. | sizing agent) |
| K223QM | Mitsubishi Kagaku | carbon fiber (with |
| | Sanshi Co. | sizing agent) |
| RG Myldo | Ineos Chemical Co. | alumina fiber (Al₂O₃) |
| SM90-SAZ-T40 | Shin-Nikka | silica-calcia-magnesia |
| | Thermal Co. | |
| Nylon staple | Toray Co. | fiber |
| T60#50 | Toray Co. | PET film |
| Calcium | Siraishi Calcium | Spherical fine |
| carbonate | | |
| SSB Red | Co. | particles (Ave. |
| | | diameter: 2.3 μm) |

### Example 1

To prepare a base member containing a non-spherical filler, there was prepared a reactive urethane coating solution as described below having a blending ratio as described in Table 1.

### Reactive Urethane Coating Solution:

| | | |
|---|---|---|
| Pluxcel L212A1 (Dycel Kagaku Kogyo Co., | 29% | by weight |
| caprolactone polyol) | | |
| Desmodule Z4470 (Sumitomo-Bayer Urethane | 16.3% | by weight |
| Co., IPDI trimer) | | |
| Alborex YS4 (Shikoku Kasei Co. aluminum | 2% | by weight |
| borate whisker) | | |
| Methyl ethyl ketone | 0.5% | by weight |
| DBTDL (dibutyltin dilaurate) | 0.02% | by weight |

A biaxially stretched polypropylene film of a thickness of about 100 μm was prepared, a reactive urethane coating solution prepared above was applied onto one surface thereof by using a bar coater, and was heated and dried in a hot-air oven heated at 80° C. so as to be cured by reaction, There was obtained a base member (film) having a thickness of about 150 μm. Next, a coloring layer of a thickness of about 25 μm and a clear layer of a thickness of about 50 μm were successively laminated on the obtained base member. The coloring layer and the clear layer were formed by using the coating solutions of the following compositions in compliance with the above-mentioned method of preparing the base member. There was obtained a 3-layer composite film comprising a base member, a coloring layer and a clear layer.

### Coating Solution for Coloring Layer:

| | | |
|---|---|---|
| TX-6013 (Nihon Yushi BASF Coatings Co., | 100% | by weight |
| urethane coating material, silver metal- | | |
| lic color) | | |
| Desmodule Z4470 (Sumitomo-Bayer Urethane | 10% | by weight |
| Co., IPDI trimer) | | |

### Coating Solution for Clear Layer:

| | | |
|---|---|---|
| TONE 0201 (Union Carbide Co., caprolac- | 54% | by weight |
| tone polyol) | | |
| UA-702 (Mitsui-Takeda Chemical Co., | 9% | by weight |
| acrylic polyol) | | |
| Desmodule Z4470 (Sumitomo-Bayer Urethane | 78% | by weight |
| Co., IPDI trimer) | | |
| n-Butyl acetate | 3% | by weight |
| DBTDL (dibutyltin dilaurate) | 0.03% | by weight |

After the 3-layer composite film was prepared as described above, a pressure-sensitive adhesive solution of the following composition was applied onto a separately prepared biaxially stretched PET liner (with the silicone releasing treatment) of a thickness of about 120 μm, and was dried.

### Pressure-Sensitive Adhesive Solution:

| | | |
|---|---|---|
| SK dyne 1310 (Sokenkagakusha Co., acrylic | 100% | by weight |
| sticking agent) | | |
| Colonate L45 (Nihon Polyurethane Co., | 1.5% | by weight |
| polyisocyanate curing agent) | | |

The above 3-layer composite film was laminated on the obtained photo-sensitive adhesive layer of a thickness of about 35 μm in a manner that the back surface of the base member of the 3-layer composite film was intimately adhered to the pressure-sensitive adhesive layer. There was obtained a 4-layer composite film (ornamental film) with a liner.

### Examples 2 to 26

Reactive urethane coating solutions were prepared as described in Example 1 with the exception of changing the non-spherical filler and the blending ratio (% by weight) thereof as described in Table 1 below. Thereafter, 3-layer composite films comprising the base member, coloring layer and clear layer were prepared according to the method described in Example 1 above, and 4-layer composite films (ornamental films) with a liner were prepared according to the method described in Example 1.

### Comparative Example 1

A reactive urethane coating solution was prepared in the same maimer as described in Example 1 but without being blended with the non-spherical filler as described in Table 1 appearing below for comparison. Next, a 3-layer composite film comprising the base member, coloring layer and clear layer was prepared according to the method described in Example 1, and a 4-layer composite film (ornamental film) with a liner was prepared.

### Comparative Example 2

A reactive urethane coating solution was prepared in the same maimer as described in Example 1 but changing the blending amount of Alborex YS4 (Shikoku Kasei Co., aluminum borate whisker) which is a non-spherical filler from 2% by weight into 1% by weight as described in Table 1 below for comparison. Next, a 3-layer composite film comprising the base member, coloring layer and clear layer was prepared according to the method described in Example 1, and a 4-layer composite film (ornamental film) with a liner was prepared.

### Comparative Example 3

A reactive urethane coating solution was prepared in the same manner as described in Example 1 but using, as a non-spherical filler, Tismo N (Ohtsu coated ka Kagaku Co., potassium titanate whisker) instead of using Alborex YS4 (Shikoku Kasei Co., aluminum borate whisker) and changing the blending amount of the non-spherical filler from 2% by weight into 1% by weight as described in Table 1 below for comparison. Next, a 3-layer composite film comprising the base member, coloring layer and clear layer was prepared according to the method described in Example 1, and a 4-layer composite film (ornamental film) with a liner was prepared.

### Comparative Example 4

The method described in Example 1 above was repeated. In this example, however, no step was employed for preparing the base member containing the non-spherical filler from the reactive urethane coating solution but, instead, a biaxially stretched PET film, T60#50 (Toray), having a thickness of about 50 μm was used as a base member for comparison. The base member was treated with corona discharge on the side of the coloring layer. Next, a 3-layer composite film comprising the base member, coloring layer and clear layer was prepared according to the method described in Example 1, and a 4-layer composite film (ornamental film) with a liner was prepared.

### Comparative Examples 5 and 6

A reactive urethane coating solution was prepared in the same manner as described in Example 1 but using calcium carbonate SSB red (Shiroishi Calcium Co., average particle size of 2.3 μm) which is a spherical filler instead of using Alborex YS4 (Shikoku Kasei Co., aluminum borate whisker) which is a non-spherical filler and changing the blending amount of the spherical filler from 2% by weight into 10% by weight (Comparative Example 5) and into 15% by weight (Comparative Example 6). Next, 3-layer composite films comprising the base member, coloring layer and clear layer were prepared according to the method described in Example 1, and 4-layer composite films (ornamental films) with a liner were prepared.

### Test Example 1

A total of 32 kinds of ornamental films prepared in Examples 1 to 26 and in Comparative Examples 1 to 6 were evaluated for their scratch resistance and three-dimensional curved surface follow-up property in accordance with the procedure described below.

Evaluation of Scratch Resistance Pencil scratch values were measured in accordance with a method of measuring the pencil scratch values (hand scratch method) specified under JIS K 5400 8.4.2 to evaluate the “scratch resistance”.

After the PET liner was peeled off from the ornamental film (4-layer composite films with liner), the ornamental film on the side of the base member was press-adhered onto an aluminum plate (9 cm×9 cm) having a flat surface. Next, the obtained aluminum plate with film was left to stand at normal temperature and normal humidity (about 25° C., about 65% RH) for 48 hours to prepare the samples.

### Measurement of Pencil Scratch Values (Hand Scratching Method):

The surface of the sample ornamental film was scratched with pencils of core hardnesses of 9H to 6B specified under the JIS S6006. The load of the pencil was 1 kg and the scratching angle was 45 degrees. The surface of each ornamental film was measured 5 times while varying the core hardness of the pencils, and damage of the films was observed by naked eyes. The samples having damage in the film were represented by X and the samples without damage in the film were represented by O. Upon scratching 5 times, the samples without damage (O) to the films even after 3 or more times by using the highest core hardness were regarded to be pencil scratch values (judging level). The results of evaluation were as shown in Table 1 below.

Evaluation of Three-Dimensional Curved Surface Follow-Up Property Body on which to be adhered:

As illustrated in FIG. 2(A), a coating plate 20 having a semi-spherical recessed portion 21 with a diameter d of about 5 mm and a depth p of about 4 mm was prepared. The coating plate 20 was made of a steel and of which the surface was electrostatically coated with a melamine resin coating material.

### Testing Method:

The ornamental films (4-layer composite films with liner) prepared in Examples 1 to 26 and in Comparative Examples 1 to 6 were cut into test pieces measuring 25 mm×70 mm. PET liners were peeled off the test pieces. Thereafter, each test piece was stuck to the horizontal surface of the coating plate 20 with the base member on the lower side as shown in FIG. 2(B). Next, as shown in FIG. 2(C), the test piece 10 was pushed onto the recessed portion 21 of the coating plate 20 so as to go along the curved surface of the recessed portion 21.

In sticking the test pieces, those test pieces are represented by O when they could be intimately adhered and stuck onto the curved surface of the recessed portion 21 without developing such inconveniences as cut or cracks in the ornamental film, and are represented by X when they could not be intimately adhered and stuck onto the curved surface of the recessed portion 21 due to the occurrence of wrinkles during the sticking operation. The results of evaluation were as described in Table 1 below.

TABLE 1

| | | | | | | Three- |
|---|---|---|---|---|---|---|
| | | | | | Pencil | dimensional |
| | | | | Amount of | scratch | curved |
| | Filler | | | filler | value | surface |
| No. of | | diameter × | Base | incorporated | (core | follow-up |
| Example | type | length | member | (wt %) | hardness) | property |
| Comp. | no | | Pluxcel | 0 | 4B | ◯ |
| Ex. 1 | incorporation | | L212AL | | | |
| Comp. | aluminum | 0.5-1.0 × 10- | Pluxcel | 1 | 4B | ◯ |
| Ex. 2 | borate whisker: | 30 μm | L212AL | | | |
| Ex. 1 | Alborex YS4 | | | 2 | 3B | ◯ |
| Ex. 2 | | | | 3 | 3B | ◯ |
| Ex. 3 | | | | 4 | 2B | ◯ |
| Ex. 4 | | | | 5 | 2B | ◯ |
| Ex. 5 | | | | 9 | B | ◯ |
| Ex. 6 | | | | 16.5 | B | ◯ |
| Ex. 7 | | | | 30 | F | ◯ |
| Ex. 8 | | | | 40 | F | ◯ |
| Ex. 9 | | | | 50 | F | ◯ |
| Ex. 10 | | | | 60 | F | ◯ |
| Ex. 11 | zinc oxide | 0.2-3.0 × 2- | Pluxcel | 9.0 | 3B | ◯ |
| | whisker: | 50 μm | L212AL | | | |
| | Panatetra | | | | | |
| | WZ-0501 | | | | | |
| Comp. | potassium | 0.3-0.6 × 10- | Pluxcel | 1 | 4B | ◯ |
| Ex. 3 | titanate | 20 μm | L212AL | | | |
| Ex. 12 | whisker: | | | 2 | 2B | ◯ |
| Ex. 13 | Tismo N | | | 3 | B | ◯ |
| Ex. 14 | | | | 4 | B | ◯ |
| Ex. 15 | | | | 5 | B | ◯ |
| Ex. 16 | | | | 9 | B | ◯ |
| Ex. 17 | | | | 16.5 | B | ◯ |
| Ex. 18 | | | | 30 | F | ◯ |
| Ex. 19 | | | | 40 | F | ◯ |
| Ex. 20 | | | | 50 | H | ◯ |
| Ex. 21 | | | | 60 | H | ◯ |
| Ex. 22 | carbon fibers: | 10 × 50 μm | Pluxcel | 12.5 | B | ◯ |
| | K6371M | | L212AL | | | |
| | (with sizing | | | | | |
| | agent) | | | | | |
| Ex. 23 | carbon fibers: | 10 × 50 μm | Pluxcel | 12.5 | HB | ◯ |
| | K223QM | | L212AL | | | |
| | (with sizing | | | | | |
| | agent) | | | | | |
| Ex. 24 | alumina fibers: | 3.0-3.5 μm | Pluxcel | 12.5 | B | ◯ |
| | RG Myldo | (diameter) | L212AL | | | |
| Ex. 25 | SM90-SAZ- | 3.9 × 118 μm | Pluxcel | 12.5 | B | ◯ |
| | T40 | | L212AL | | | |
| | (silica-calcia- | | | | | |
| | magnesia) | | | | | |
| Ex. 26 | nylon staple | 11 × 100- | Pluxcel | 12.5 | B | ◯ |
| | fibers | 200 μm | L212AL | | | |
| Comp. | — | | PET film | 0 | B | X |
| Ex. 4 | | | (T60#50) | | | |
| Comp. | calcium | Ave. particle | Pluxcel | 10 | 4B | ◯ |
| Ex. 5 | carbonate SSB | diameter | L212AL | | | |
| Comp. | Red | 2.3 μm | | 15 | 3B | ◯ |
| Ex. 6 | | | | | | |

### Concerning the Scratch Resistance:

As will be understood from the evaluation results in Table 1 above, when the base member is blended with non-spherical fine filler particles according to the present invention, the scratch resistance can be markedly improved as compared to the conventional technology. As compared to when the base member is blended with the spherical fine filler particles, further, the scratch resistance can be achieved to a comparatively satisfactory degree despite of a small blending amount. The scratch resistance can be further improved with an increase in the amount of blending the non-spherical fine filler particles.

### Concerning the Three-Dimensional Curved Surface Follow-Up Property:

As will be understood from the evaluation results in Table 1 above, when the base member is blended with non-spherical fine filler particles according to the present invention, the three-dimensional curved surface follow-up property can be markedly improved as compared to the conventional technology. As compared to when the base member is blended with the spherical fine filler particles, further, the three-dimensional curved surface follow-up property can be achieved to a comparatively satisfactory degree despite of a small blending amount.

### Test Example 2

A total of 17 kinds of ornamental films prepared in Examples 1, 2, 4, 7, 9, 10, 12, 15, 18, 20 and 22 to 26 and in Comparative Examples 1 and 2 were measured for their tensile modulus values in accordance with the procedure described below, and were evaluated.

The ornamental films were cut into test pieces measuring 10 mm×100 mm. PET liners were peeled off the test pieces. Thereafter, each test piece was set to a tensile jig of a tensile testing machine (trade name: Tensilon UCT-100, manufactured by Orientech Co.), and was pulled at a rate of 200 mm/min. While continuing the pulling, a tensile stress (tensile modulus value) of when the test piece is stretched by 50%) was measured. A direction in which the reactive urethane coating solution was applied to the ornamental film was regarded to be the MD and the direction at right angles therewith was regarded to be the CD, and the tensile modulus values were measured in the respective directions. There were obtained the measured results as described in Table 2 below.

TABLE 2

Modulus at 50% stretching (N)

| No. of Example | MD direction | CD direction |
|---|---|---|
| Comparative Example 1 | 11.6 | 11.1 |
| Comparative Example 2 | 11.7 | 11.5 |
| Example 1 | 12.3 | 11.9 |
| Example 2 | 12.5 | 12.1 |
| Example 4 | 13.1 | 12.4 |
| Example 7 | 20.8 | 14.3 |
| Example 9 | 22.8 | 15 |
| Example 10 | 27.3 | 16.6 |
| Example 12 | 12.9 | 12.4 |
| Example 15 | 14.7 | 12.6 |
| Example 18 | 30.7 | 20.3 |
| Example 20 | 34.3 | 20.3 |
| Example 22 | 15.2 | 14.2 |
| Example 23 | 22.2 | 15.1 |
| Example 24 | 14.6 | 13.6 |
| Example 25 | 20.1 | 14.6 |
| Example 26 | 34.3 | 20.3 |

As will be understood from the measurement results in Table 2 above, when the base member is blended with non-spherical fine filler particles according to the present invention, it is made possible to impart anisotropy in the tensile strength of the obtained ornamental film and to freely control the tensile strength in the MD and CD by varying the kind of the filler and the blending amount thereof.

1. An ornamental film comprising a base member, a coloring layer formed at least partly on the surface of the base member, and a pressure-sensitive adhesive layer formed on the back surface of the base member, wherein said base member is blended, as a filler, with non-spherical fine particles of aluminum borate, potassium titanate or a combination thereof.

2. An ornamental film according to claim 1, wherein said non-spherical fine particles are fibers or whiskers.

3. An ornamental film according to claim 1, wherein said non-spherical fine particles are blended in an amount of 2 to 60% by weight based on the whole amount of the base member.

4. An ornamental film according to claim 1, wherein said non-spherical fine particles are blended in an amount in the range of from 2% to 15% by weight based on the whole amount of the base member.

5. An ornamental film according to claim 1, wherein said non-spherical fine particles have a length in the range of from 5 μm to 50 μm on the average.

6. An ornamental film according to claim 1, wherein said base member comprises a reactive polyurethane resin, a polyester resin or a polyolefin resin.

7. An ornamental film according to claim 6, wherein said polyolefin resin is a polypropylene, a polyethylene, a thermoplastic olefin, an ionomer, an ethylene/acrylic acid copolymer, an ethylene/ethyl acrylate copolymer or an ethylene/vinyl acetate copolymer.

8. An ornamental film according to claim 1, wherein said base member has a thickness in a range of 10 to 1,000 μm.

9. An ornamental film according to claim 1, wherein said base member is a coated film.

10. An ornamental film according to claim 9, wherein said coated film is a film formed by a knife coating method, a bar coating method, a blade coating method, an air doctor coating method, a roll coating method or a cast coating method.

11. An ornamental film according to claim 10, wherein said coated film is formed by the bar coating method.

12. An ornamental film according to claim 1, wherein said coloring layer is formed by a printing method, a transfer method, a vacuum evaporation method, a film sticking method, a bar coating method or a spray coating method.

13. An ornamental film according to claim 1, wherein said coloring layer has a thickness in a range of 1 to 300 μm.

14. (canceled)

15. (canceled)

16. An ornamental film according to claim 1, further comprising a top-coated layer on the color layer.

17. An ornamental film according to claim 16, wherein said top-coated layer comprises an urethane resin.

18. An ornamental film according to claim 17, wherein the urethane resin forming said top-coated layer is a two-can urethane resin.

19. An ornamental film according to claim 1, wherein said top-coated layer has a thickness in a range of 1 to 300 μm.

20. An ornamental film according to claim 1, further comprising a carrier film.

21. An ornamental film according to claim 1, which is stuck to a body or armoring parts of an automobile via said pressure-sensitive adhesive layer.

22. An ornamental film according to claim 1, wherein said non-spherical fine particles have a diameter in the range of from 0.3 μm to 1.0 μm on the average.
